(19) United States
(12) Patent Application Publication
(10) Pub. No.: US 2020/0098013 A1
(43) Pub. Date: Mar. 26, 2020

(54) METHODS AND APPARATUS TO COLLECT AUDIENCE MEASUREMENT DATA ON COMPUTING DEVICES

(71) Applicant: The Nielsen Company (US), LLC, New York, NY (US)

(72) Inventors: Pararth Mehta, Mumbai (IN); Pankaj Bengani, Mumbai (IN); Nigel Smith, Richardson, TX (US); Travis Berthelot, Lewisville, TX (US); Achilleas Papakostas, Dallas, TX (US)

(21) Appl. No.: 16/197,307

(22) Filed: Nov. 20, 2018

(30) Foreign Application Priority Data
Sep. 22, 2018 (IN) 201811035731

(51) Int. Cl. G06Q 30/02; G06F 3/0481; G06F 3/0482

(52) U.S. Cl. CPC G06Q 30/0272; G06Q 30/0201; G06F 3/0482; G06F 3/04812

(57) ABSTRACT

Methods, apparatus, systems and articles of manufacture are disclosed to collect audience measurement data on computing devices. An example apparatus includes an accessibility event receiver to obtain event data from an accessibility application programming interface of a computing device, an event repository coupled to the accessibility event receiver, the event repository to store the event data, an event filter coupled to the event repository, the event filter to filter the event data based on a set of rules to identify media presentation information, a measurement data generator coupled to the event filter, the measurement data generator to generate media measurement information based on the media presentation information, and a data transmitter coupled to the measurement data generator to transmit the media measurement information to a collection facility.

### FIELD OF THE DISCLOSURE

This disclosure relates generally to audience measurement data in computing devices, and, more particularly, to methods and apparatus to collect audience measurement data on computing devices.

### BACKGROUND

Various On Device Meters (ODM) have been used by audience measurement entities to collect data about media consumed on computing device. However, the restrictions imposed by operating systems of mobile devices (e.g., smartphones) limit the ability of ODMs to collect information. Further, there is increased interest in what users are doing within the apps (e.g., videos being watched on YouTube or Netflix, products being purchased on Amazon or songs being listened to).

### BRIEF DESCRIPTION OF THE DRAWINGS

FIG. 1 is a block diagram illustrating an example flow of information between the collection facility, content provider, and user device within the network.

FIG. 2 is a block diagram illustrating an example implementation of the meter of FIG. 1.

FIG. 3 is a block diagram of an example implementation of the back-end data processor of FIG. 1.

FIG. 4 illustrates example data types that may be collected by the meter of FIG. 1 and/or FIG. 2.

FIG. 5 illustrates example datasets received from the Android Accessibility Service.

FIG. 6 illustrates example input data to be mapped to an event.

FIG. 7 is a flowchart representative of machine readable instructions that may be executed to collect and measure event data from the user device of FIG. 1.

FIG. 8 is a flowchart representative of machine readable instructions that may be executed to generate measurement data in the meter of FIG. 1 and/or FIG. 2.

FIG. 9 is a flowchart representative of machine readable instructions that may be executed process the data in the back-end data processor of FIG. 1 and/or FIG. 3.

FIG. 10 is a flowchart representative of machine readable instructions that may be executed to apply necessary algorithms to the data.

FIG. 11 is a flowchart representative of machine readable instructions that may be executed to detect problems encountered in the back-end data processor of FIG. 1 and/or FIG. 3.

FIG. 12 is a block diagram of an example processing platform structured to execute the instructions of FIGS. 7-8 to implement the meter of FIG. 1 and/or FIG. 2.

FIG. 13 is a block diagram of an example processing platform structured to execute the instructions of FIGS. 9-11 to implement the back-end data processor of FIG. 1 and/or FIG. 3.

The figures are not to scale. In general, the same reference numbers will be used throughout the drawing(s) and accompanying written description to refer to the same or like parts.

### DETAILED DESCRIPTION

To obtain pre-authorized data (e.g., user information, user actions, duration spent performing an action) from an electronic device, such as a cellphone, personal laptop, personal computer, tablet, or smart watch, a meter may collect and store data (e.g., user information, user actions, duration spent performing an action). Typically, these meters are installed in the form of a downloadable application.

Examples disclosed herein allow the end user to obtain the meter by signing up on a third-party site (e.g., place of business or online website) and having the example meter sent to them virtually or physically, downloading the meter via a virtual app or physical memory storage device, or downloading a program via a virtual app or physical memory storage device in which the program described above contains the meter.

Examples disclosed herein include a group of panelists in which the panelists in the group are the users of the user device. These panelists are selected voluntarily or involuntarily. Alternatively, the group of panelists may include a non-human group in which the actions are recorded and measured in the same way.

An example meter utilizes the Android Accessibility Service for developers. The Android Accessibility service is a feature of the Android framework designed to provide or allow for the collection of alternative navigation feedback to the user on behalf of applications installed on Android devices. An accessibility service can communicate to the user on the application's behalf, such as converting text to speech, or haptic feedback when a user is hovering on an important area of the screen. The Android Accessibility Service runs in the background and receives callbacks by the system when a user event occurs. The user event may be in the form of audio and/or videos played, websites accessed, online products purchased, etc. Likewise, another example of a user event may denote some state transition in the user interface (e.g., the focus has changed, a button has been clicked, etc.).

The example meter registers with the Android Accessibility Service by a request for permission, user permission, manually by the user through an accessibility server, directed to the user to enable it, or any method of enabling the accessibility service not directly disclosed herein. Implementing the meter using the Android Accessibility Service allows the meter to obtain all the widget details in any Android application that the Android Accessibility Service has access to.

The example meter transmits collected data to a collection facility. The collection facility receives the data containing information including but not limited to media being played, track mode operations (e.g., fast forward, play), duration played, and advertisements displayed while content is playing. The meter in this form is including but not limited to a pre-downloaded application.

The example meter implemented according to the disclosure may provide history for users as a service. This could help the user see media history across multiple applications. Additionally, the meter may log and/or record events performed by the user on the user device. Examples disclosed herein include accessing the meter on a user device to determine an action performed on the user device.

In another example, metering may be done through the use of intent filters (e.g., user actions within the application, media data, video frames) which specify exactly what data to collect from the user device.

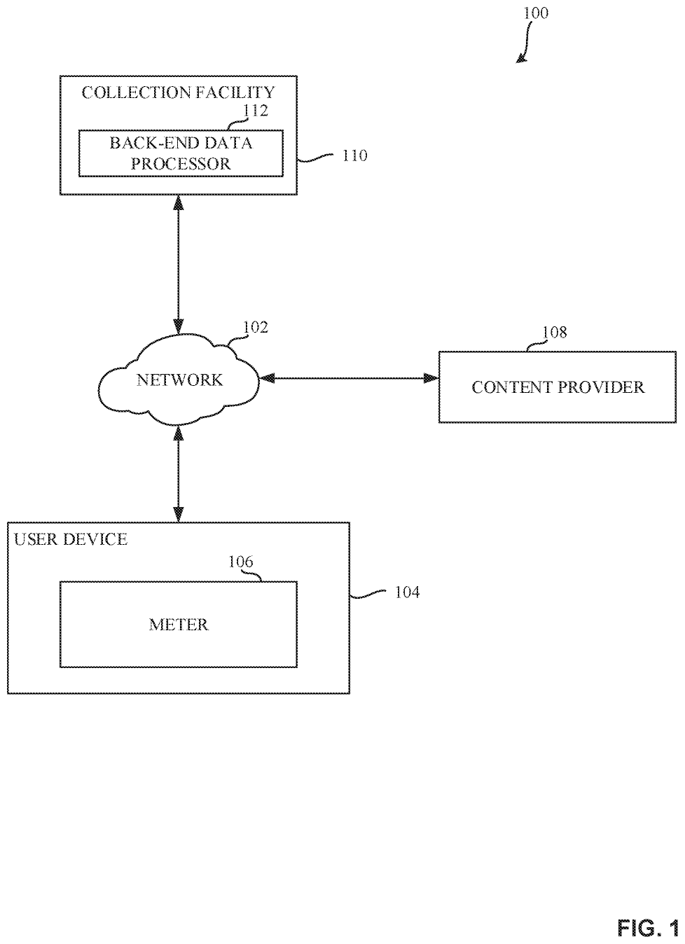

FIG. 1 is a block diagram 100 illustrating an example flow of information between the collection facility 110, content provider 108, and user device 104 within the network 102. The example meter 106 transmits the audience measurement data (e.g., event data) to an example collection facility 110. The collection facility 110, content provider 108, and user device 104 communicate to each other via the network 102. The meter 106, as disclosed, is contained in the user device 104 (e.g., in the form of an application). According to the illustrated example, the meter 106 collects data (e.g., event data) about the operation of the applications on the user device 104 using the Accessibility Service.

The example network 102 is a communications network. The example network 102 allows the user device 104, the content provider 108, and the example collection facility 110 to interface with each other to provide audience measurement data (e.g., event data) via a wired and/or wireless analog and/or digital network communication. Example wired and/or wireless analog and/or digital network communications include Zigbee, microwaves, lasers for wireless, fiber cable, communication cable, satellite communications, quantum teleportation, local area network, wide area network, personal area network, wireless local area network, the Internet, a cloud, or any other type of wired and/or wireless analog and/or digital communications network.

The example user device 104 is a computing device which enables a user to connect to an example network 102 and perform actions on applications within the user device 104. The user device 104 may include, but not limited to, a cellular phone, portable tablet, personal computer, laptop, smart watch, or gaming consoles. The example user device 104 may contain downloadable content in which the user may interact with. This data (e.g., event data) may be accessible by the meter 106 installed on the device.

The example meter 106 may be in the form of a downloadable application. For example, the application may be downloaded onto the user device 104 by the device owner (e.g., the individual who is accessing content from the content provider 108 on the user device 104) from an application store (e.g., App Store®, Google Play™, etc.). Additionally, the example meter 106 may be downloaded onto the user device 104 through the metering authority (one who is initiating the metering). For example, a user may log onto the metering authority's website and downloading from the metering authority servers. Alternatively, the meter may be downloaded via side-loading, such as USB, Bluetooth, Wi-Fi, etc. The example meter 106 is accessible by the collection facility 110 via the network 102. The example meter 106 measures data (e.g., event data) on the user device 104. The data (e.g., event data) may be in the form of, but not limited to, video watched, name of video, genre, time spent on video, product viewed, or product searched for.

The example content provider 108 is a third-party content host which provides content (e.g., movies, songs, or news articles) to the user device 104 via the network 102. The content provider 108 may generate, provide, or facilitate content on the user device 104. Example content providers may include Netflix, Hulu, The Washington Post, or Spotify. The content provider 108 may provide content to the user device 104 directly through a wired connection.

The example collection facility 110 collects and manages event data from the user device 104. The event data from the example collection facility 110 is then manipulated, organized, or sorted into measurable figures.

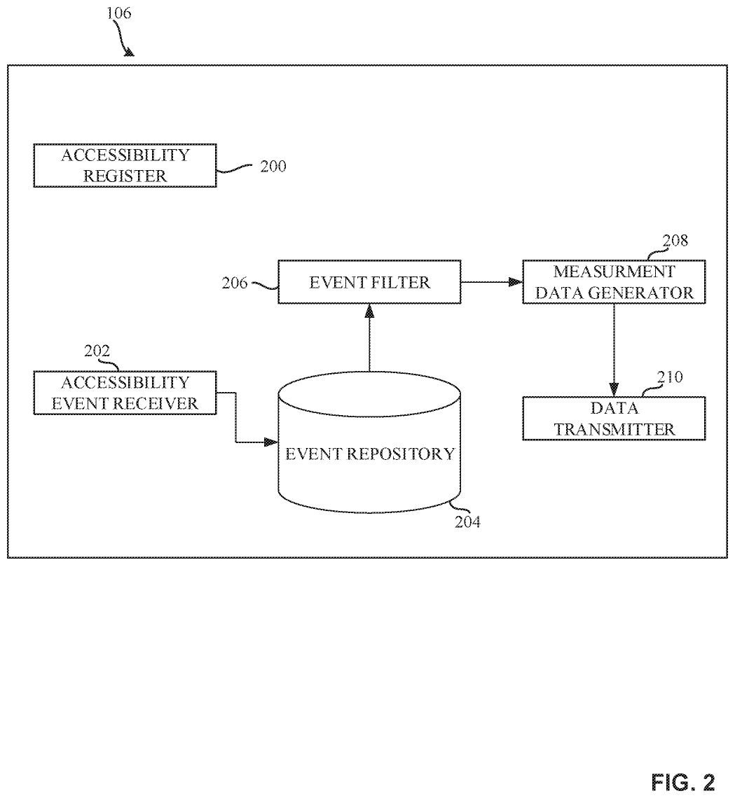

FIG. 2 is a block diagram illustrating an example implementation of the meter 106 of FIG. 1. An example accessibility register 200 registers the meter 106 with the operating system to receive Accessibility Service events (herein referred to as data, onscreen data points, accessibility event data, event data, etc.). Event data from the user actions includes but is not limited to, media being played, track mode operations (fast forward, play, etc.), duration played, and advertisements displayed while content is playing. The example meter 106 contains an example accessibility event receiver 202, an example event repository 204, an example event filter 206, an example measurement data generator 208, and an example data transmitter 210 which all may be coupled on the example meter.

The example accessibility register 200 allows the meter 106 on the user device 104 to affirm the meter 106 is installed through the Android Accessibility Service. The Android Accessibility Service allows the meter 106 to read and store the user device 104 screen content. Examples disclosed herein include the accessibility register 200 to gain access to the Android Accessibility Service. The accessibility register 200 may initiate registration of the meter 106 on the user device 104 through user-initiated operation.

The example accessibility event receiver 202 collects and receives onscreen data points (e.g., event data) in the form of, but not limited to, audio and/or videos played, websites accessed, online products purchased, viewing titles, or viewing times. The example accessibility event receiver 202 may be a dual-transceiver which allows the example accessibility event receiver 202 to receive event data and transmit the event data. The example accessibility event receiver 202 may transmit and/or receive example event data in the form of wireless and/or wired analog and/or digital communication. In examples disclosed herein, the event data may be accessibility event data. Example wired and/or wireless analog and/or digital network communications include Zigbee, microwaves, lasers for wireless, fiber cable, satellite communications, quantum teleportation, communication cable, local area network, wide area network, personal area network, wireless local area network, the Internet, a cloud, or any other type of wired and/or wireless analog and/or digital communications network. The accessibility event receiver 202 continuously monitors events that occur on the user device 104. The accessibility event receiver 202 may also receive emitted events. In response to determining an accessibility event has occurred, the accessibility event receiver will retrieve the accessibility event from the accessibility register 200. These events are then transmitted to the local event repository 204.

The example event repository 204 captures and stores user data (e.g., event data) received from the accessibility event register. The event data may be stored in the event repository in the form of flash memory, external flash memory card, readable access memory (RAM), or external cloud storage services. Alternatively, the event repository 204 may be a local, on-device database. Event data stored in the event repository 204 may include any information pertinent to an event which occurs on the user device 104. For example, the event repository 204 may store information pertaining to shows watched, advertisements views, viewing durations, websites visited, etc. Additionally, the event repository may be a server cluster such as a Hadoop Distributed File System (HDFS). Event data stored in the event repository 204 is stored until later filtered by the event filter 206 (e.g., the event filter 206 filters the event data stored in the event repository 204).

The example event filter 206 receives event data from the event repository and organizes based on file type or data type. In this example, the event filter may organize the event data from the event repository 204 in the form of accepted or rejected data. For example, accepted event data may include user data pertaining to video's being watched, time spent on video, or advertisements clicked on. For example, rejected event data may include data that provides little or no value to the monitoring system. The types constraints of accepted or rejected data may be predefined prior to downloading the meter 106. The event filter 206 may include a pre-specified set of rules for collection to filter unwanted data. Additionally, the pre-specified set of rules for collection include rules to filter unwanted data.

The example measurement data generator 208 receives event data from the event filter 206 and sorts the event data based on data type (e.g., event type, event class, content description, content provider description, user device brand, user device name, user device model, date and/or time, or user device operating system version). This newly measured event data is organized into an event log and stored for later transmission. Additionally, the measurement data generator 208 combines the event data with relative custom fields available.

The example data transmitter 210 transmits event data from the meter 106 through the user device 104 to the collection facility 110. The example data transmitter may be a dual-transceiver which allows the example data transmitter 210 to receive event data and transmit the event data. The example data transmitter 210 may transmit and/or receive example event data in the form of wireless and/or wired analog and/or digital communication. Example wired and/or wireless analog and/or digital communications include Zigbee, microwaves, lasers for wireless, fiber cable, satellite communications, quantum teleportation, communication cable, local area network, wide area network, personal area network, wireless local area network, the Internet, a cloud, or any other type of wired and/or wireless analog and/or digital communications network. The example data transmitter 210 may transmit the event data in the form of carrier wave. The carrier wave may be amplitude modulated, frequency modulated, or phase modulated to transmit the event data efficiently.

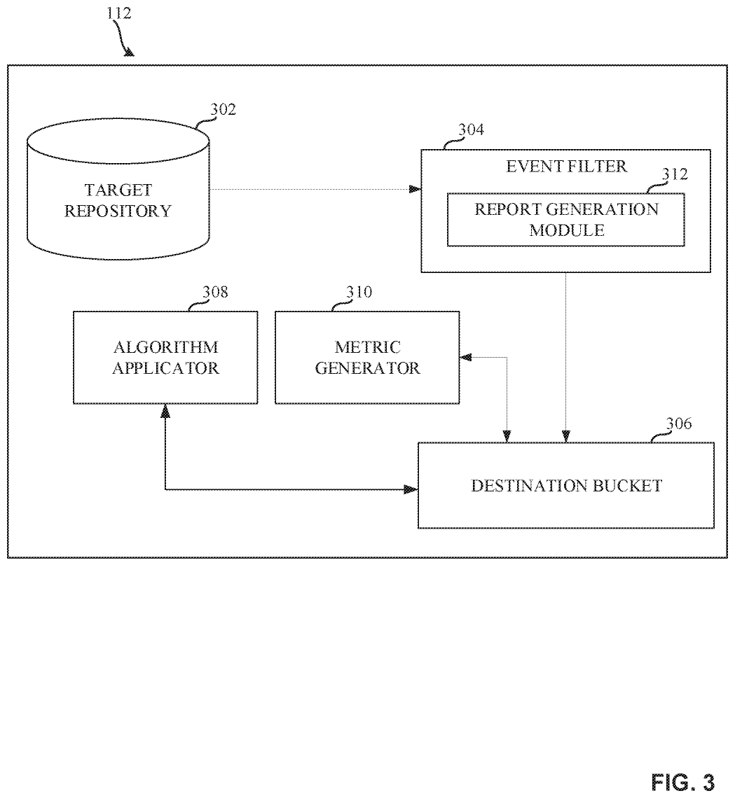

FIG. 3 is a block diagram of an example implementation of the back-end data processor 112 of FIG. 1. The back-end data processor 112 in this embodiment includes a target repository 302, an event filter 304, a destination bucket 306, a metric generator 310, and an algorithm applicator 308. The target repository 302 is coupled to the event filter 304. The event filter 304 is coupled to the destination bucket 306. Also coupled to the destination bucket 306 is the metric generator 310 and the algorithm applicator 308.

The example target repository 302 receives event data periodically from the user device 104. The target repository 302 consists of a memory which holds the raw user data. The memory may consist of flash memory, external flash memory card, readable access memory (RAM), or external cloud storage services. Additionally, event data may be transferred to a Hadoop Distributed File System (HDFS) on a cluster of virtual servers. The data transfer may be performed hourly, daily, or any other predetermined length of time.

The example event filter 304 is coupled to the target repository 302 to obtain the raw data (e.g., raw event data). The event filter 304 may also contain a report generation module 312. The event filter 304 converts the raw data type into a predetermined data type. For example, the event filter 304 may receive JavaScript Object Notation (JSON) type data from the target repository 302. The event filter 304 converts the JSON data type to parquet format. Alternatively, the event filter 304 may convert the JSON data type to any other storage format. The event filter 304 further applies any cleaning rules to the event data (e.g., masking, flagging, etc.). Additionally, the event filter 304 may perform action such as parsing data and cleaning up event data. Cleaning up event data includes removing duplicate instances, incomplete instances, and/or unwanted instances of event data. The report generation module 312 tracks the health of the Panel and may post information concerning the health of the Panel.

The example destination bucket 306 is coupled to the event filter 304, the algorithm generator 308, and the metric generator 310. The destination bucket 306 receives the converted event data from the filter 304. Additionally, the destination bucket 306 is coupled to the algorithm applicator 308.

The example algorithm applicator 308 is coupled to the destination bucket 306. The algorithm applicator 308 may receive the converted event data from the destination bucket 306. The algorithm applicator 308 may also be considered a rules engine. The example algorithm applicator 308 contains a list of conditions and executions. The conditions and executions may be received internally or externally. The algorithm applicator 308 checks against the conditions to determine whether or not to perform the executions. Examples include extracting and tagging relevant information from the converted event data. The algorithm applicator 308 may perform relevant logic to extract and tag the information. Additionally, the algorithm applicator 308 utilizes the rules which apply to the intermediate event data to generate meaningful output. The output includes the reported events typically placed in a database.

The metric generator 310 is coupled to the destination bucket 306. The metric generator 310 receives event data from the destination bucket 306. The metric generator 310 detects any problems that may have occurred during extraction and tagging by the algorithm applicator 308. Examples disclosed herein include generating a report to check if the algorithm applicator 308 correctly evaluated the converted data. Additionally, the metric generator 310 may generate a report to check if the algorithm applicator 308 correctly evaluated the converted event data across different versions.

An example implementation includes, with respect to Video On Demand (VOD) content, the event filter 304 extracting all relevant VOD data, filtering out the irrelevant data, and/or extract metrics (e.g., content name, user action, and/or search terms). The algorithm applicator 308 applies the necessary extraction algorithms to the event data. This extracted data is then used by the event filter 304, more specifically, the report generation module 312, to create and/or generate a report based on the filtered and extracted data.

Another example implementation includes applying the algorithm process to eCommerce data. eCommerce data may include specific information about products viewed, products purchased, etc. In this example, similar algorithm steps are applied. The event filter 304 will extract and tag all information from the meter. Additionally, the event filter 304 may apply filtering techniques to filter out the irrelevant data. For example, in eCommerce applications, the types of data that may be considered relevant include products viewed, categories viewed, cart view amount, etc. Additionally, there may be additional personally identifiable information, such as credit card numbers, etc., which need to be masked. Therefore, appropriate rules may be applied to perform the masking. Once the data is filtered and/or masked, metrics such as product information, product name, product price, etc., are extracted from the data by the metric generator 310. The algorithm applicator 308 applies the necessary extraction algorithms to the data. The data is then used by the report generation module 312 to create and/or generate a report based on the filtered and extracted data for the destination bucket 306.

While an example manner of implementing the example back-end data processor 112 of FIG. 1 is illustrated in FIG. 3, one or more of the elements, processes and/or devices illustrated in FIG. 3 may be combined, divided, re-arranged, omitted, eliminated and/or implemented in any other way. Further, the example target repository 302, the example event filter 304, the example report generation module 312, the example destination bucket 306, the example algorithm applicator 308, the example metric generator 310, and/or, more generally, the example back-end data processor 112 of FIG. 3 may be implemented by hardware, software, firmware and/or any combination of hardware, software and/or firmware. Thus, for example, any of the example target repository 302, the example event filter 304, the example report generation module 312, the example destination bucket 306, the example algorithm applicator 308, the example metric generator 310, and/or, more generally, the example back-end data processor 112 of FIG. 3 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example target repository 302, the example event filter 304, the example report generation module 312, the example destination bucket 306, the example algorithm applicator 308, the example metric generator 310, and/or, more generally, the example back-end data processor 112 of FIG. 3 is/are hereby expressly defined to include a non-transitory computer readable storage device or storage disk such as a memory, a digital versatile disk (DVD), a compact disk (CD), a Blu-ray disk, etc. including the software and/or firmware. Further still, the example meter of FIG. 1 may include one or more elements, processes and/or devices in addition to, or instead of, those illustrated in FIG. 3, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

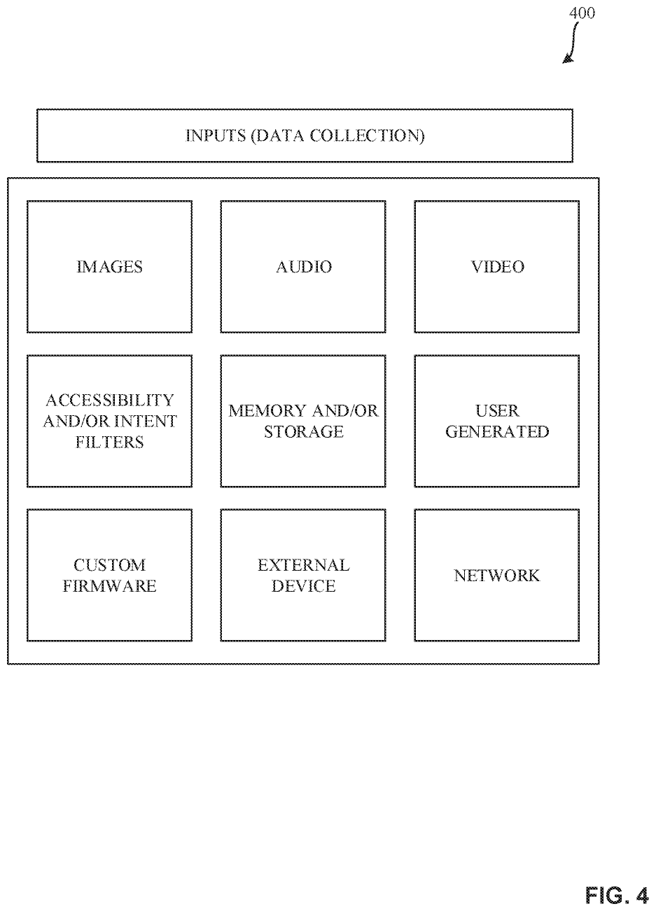

FIG. 4 illustrates example event data types 400 that may be collected by the meter 106 of FIG. 1 and/or FIG. 2. This event data includes but not limited to, images, audio, accessibility and/or intents filters, memory and/or storage, user generated, custom firmware, external device, web usage, and network data. As inputs, the meter may collect event data pertaining to specific pre-determined applications, current content data, or external data. For example, along with the application data, the meter may collect content relevant event data such as timestamps, durations, etc. The content specific data may then be paired with the pre-determined application specific data received through the Accessibility Service. The newly paired data may then be collected and sent to a back-end server for processing.

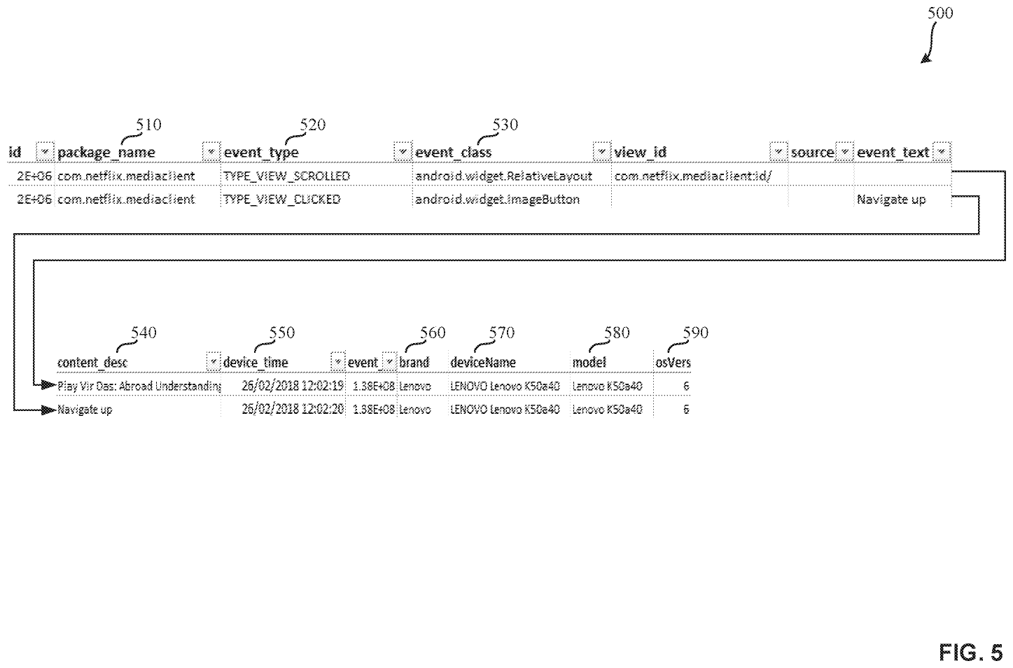

FIG. 5 illustrates example event data sets 500 received from the Android Accessibility Service. This example event data set 500 may include data types, more formally named, package_name 510, event_type 520, event_class 530, content_desc 540, device_time 550, brand 560, deviceName 570, model 580, or osVers 590. All event data sets 500 typically received by an Accessibility service that are not explicitly disclosed herein may be recorded in the above data set 500. The data set 500 received through the Android Accessibility Service is then used to be stored in the event repository 204.

The example package_name 510 gives detail on the content provider 108. This dataset may include descriptions such as com.google.android.youtube, com.amazon.avod.thirdpartyclient for YouTube and Amazon Prime Video content providers respectively. The example event_type 520 includes description on the action that was performed by the user on the user device 104. Example event_type 520 datasets include descriptions of user actions such as clicking, scrolling, or viewing. The example event_class 530 dataset includes information pertaining to where and what the user event pertains to. This includes buttons, layouts, frames, views, images, text, etc. The example content_desc 540 dataset includes information about what action was performed on the user device 104. The example device_time 550 dataset includes information showing the time and/or date in which the event occurs. This data may be in the form of 12-hour, 24-hour, or any day and/or month combination. The example brand 560, deviceName 570, model 580, and osVers 590 datasets give detail pertaining to the user device 104 being metered by the example meter 106.

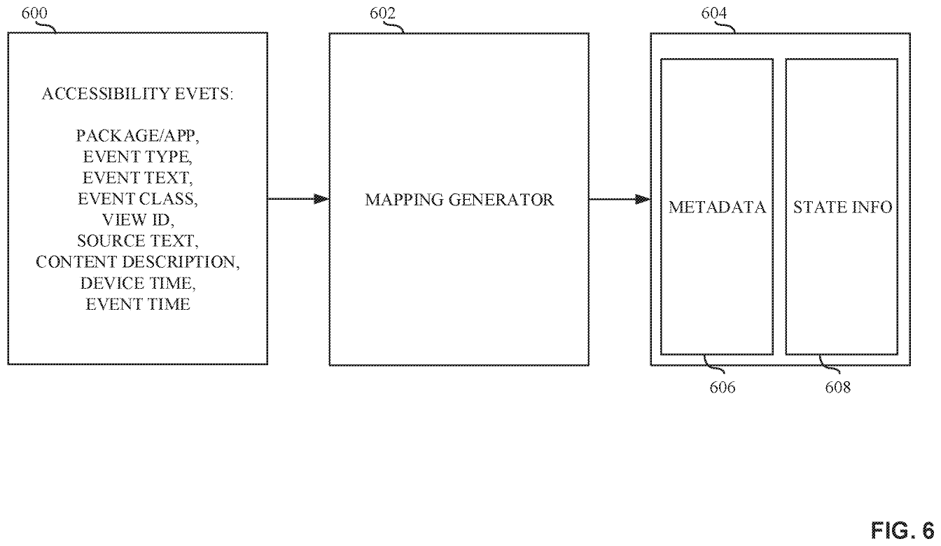

FIG. 6 illustrates example input event data to be mapped to an event 604. Raw data (e.g., raw event data) is mapped from the user device 104 into an event. Example accessibility events 600 received from the accessibility event receiver 202 disclosed herein include package, event type, event text, event class, view ID, source text, content description, device time, or event time. The accessibility events 600 are sorted by a mapping generator 602 to distinguish between metadata 606 and state info 608. The metadata 606 and state info 608 are stored as outputs.

The example accessibility events 600 (e.g., event data) include events that occur on a user device 104 which can be discovered through the Android Accessibility Service. All data obtainable though the Android Accessibility Service may be characterized as an accessibility event 600.

While an example manner of implementing the meter of FIG. 1 is illustrated in FIG. 2, one or more of the elements, processes and/or devices illustrated in FIG. 2 may be combined, divided, re-arranged, omitted, eliminated and/or implemented in any other way. Further, the example accessibility register 200, the example accessibility event receiver 202, the example event repository 204, the example event filter 206, the example measurement data generator 208, the example data transmitter 210 and/or, more generally, the example meter 106 of FIG. 1, may be implemented by hardware, software, firmware and/or any combination of hardware, software and/or firmware. Thus, for example, any of the example accessibility register 200, the example accessibility event receiver 202, the example event repository 204, the example event filter 206, the example measurement data generator 208, the example data transmitter 210 and/or, more generally, the example meter 106 of FIG. 1, could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example accessibility register 200, the example accessibility event receiver 202, the example event repository 204, the example event filter 206, the example measurement data generator 208, the example data transmitter 210 and/or, more generally, the example meter 106 of FIG. 1, is/are hereby expressly defined to include a non-transitory computer readable storage device or storage disk such as a memory, a digital versatile disk (DVD), a compact disk (CD), a Blu-ray disk, etc. including the software and/or firmware. Further still, the example meter of FIG. 1 may include one or more elements, processes and/or devices in addition to, or instead of, those illustrated in FIG. 2, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

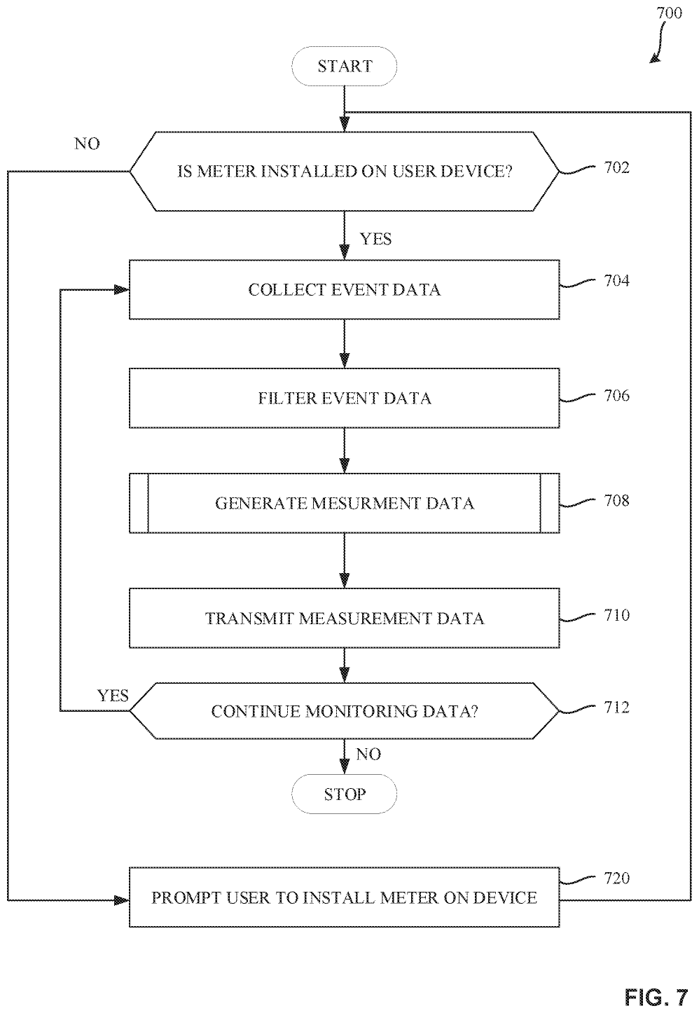

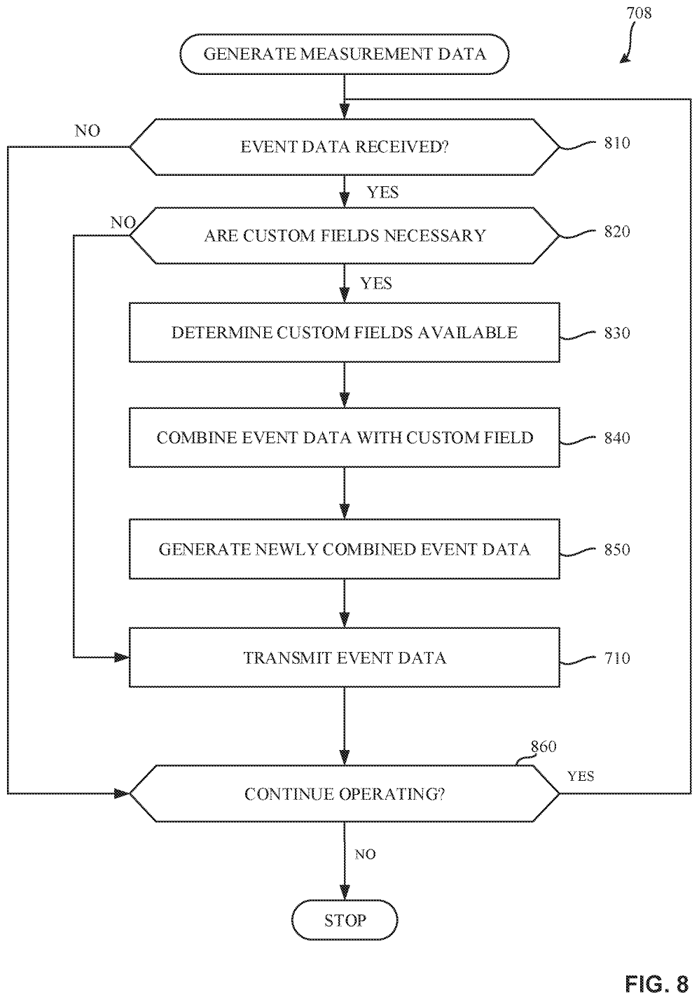

Flowcharts representative of example hardware logic, machine readable instructions, hardware implemented state machines, and/or any combination thereof for implementing the example accessibility register 200, the example accessibility event receiver 202, the example event repository 204, the example event filter 206, the example measurement data generator 208, the example data transmitter 210 and/or, more generally, the example meter 106 of FIG. 1, is shown in FIGS. 7-8. The machine readable instructions may be an executable program or portion of an executable program for execution by a computer processor such as the processor 1212 shown in the example processor platform 1200 discussed below in connection with FIGS. 7-8. The program may be embodied in software stored on a non-transitory computer readable storage medium such as a CD-ROM, a floppy disk, a hard drive, a DVD, a Blu-ray disk, or a memory associated with the processor 1212, but the entire program and/or parts thereof could alternatively be executed by a device other than the processor 1212 and/or embodied in firmware or dedicated hardware. Further, although the example program is described with reference to the flowchart illustrated in FIGS. 7-8, many other methods of implementing the example meter may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A. (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

FIG. 7 is a flowchart representative of machine readable instructions that may be executed to collect and measure event data from the user device 104 of FIG. 1. The user device 104 and/or the collection facility 110 check for the existence of a meter 106 on the user device 104 (block 702). The user device 104 and/or the collection facility 110 may scan, transmit, receive, and/or any perform other method of data transition to determine if the meter 106 is installed on the user device 104. If the meter 106 is not installed on the user device 104, the user device 104 will prompt the user to install the example meter 106 on the user device 104 (block 720). Once the meter 106 is installed on the user device 104, the meter 106 begins collecting event data (block 704). The event data received by the accessibility event receiver 202 is sent to the event repository 204 and later filtered by the example event filter 206 (block 706). The event filter 206 filtering event data may accomplish this by organizing the event data by file type, file size, and/or origin of file

The measurement data generator 208 generates measurement data (block 708) in response to obtaining the filtered event data from the event filter 206. Since this data is filtered by the event filter 206, the measurement data generator 208 organizes the event data based on filtering type before transmitting. The measurement data generator 208 organizes the event data based on specified rules set forth by the collection facility 110. The specified rules include descriptions of types data to be collected along with how the data is to be measured and organized.

The data transmitter 210 transmits the filtered measurement event data to a secondary site (block 710). In some examples disclosed herein, the event data may be transmitted back to the user device 104, to a collection facility 110 in the same network 102 as the user device 104, etc. In response, the meter 106 confirms whether or not to continue operating (block 712). Examples of when the monitoring process is to cease include device shutoff, loss of power, loss of Android Accessibility Service consent, etc. If prompted to continue, the meter 106 will continue collecting event data (block 704), otherwise, the process will stop.

FIG. 8 is a flowchart representative of machine readable instructions that may be executed to generate measurement data (block 708) in the meter 106 of FIG. 1 and/or FIG. 2. The accessibility event receiver 202 receives filtered event data though the accessibility service (block 810). The event data (e.g., data through the accessibility service) points provide information about an action that is happening within an app, for example, video streaming, online shopping, etc. Event data may consist of event type, event time, source, view ID, content description, event text, event class, and/or package name. The event data may or may not be received for all applications provided through the Accessibility Service. For example, the meter 106 may receive a pre-determined list of applications to receive on-screen data from. This may or may not be done at the example accessibility event receiver 202, the example event repository 204, the example event filter 206, and/or the example measurement data generator 208.

In response, the measurement data generator 208 determines if additional custom fields are necessary (block 820). A custom field may be, for example, node_index, which can deduce the position of a data point from a large number of records, timestamp, or app version. If the measurement data generator 208 determines that custom fields are necessary, the measurement data generator 208 determines any available custom fields (block 830). In some examples disclosed herein, the measurement data generator 208 determines that custom fields are available via communications with the network 102, the back-end data processor 112, and/or the content provider 108 of FIG. 1.

The measurement data generator 208 combines the event data points with custom fields previously determined to be available (block 840). This may be done through a process of filtering and sorting the event data points to be associated with other custom fields. The measurement data generator 208 then generates the newly combined event data (block 850). In response to combining the event data points with the necessary custom fields, the measurement data generator 208 then sends the event data to be further transmitted (block 710).

Additionally, the measurement data generator 208 determines if continuous operation is necessary (block 860). Examples in which the measurement data generator 208 fails to continuously operate include loss of power, manual shut off, loss of permission, inability to receive onscreen and/or custom field data points, etc. Otherwise, the measurement data generator 208 returns to determining if onscreen data points are received (block 810).

As mentioned above, the example processes of FIGS. 7-8 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

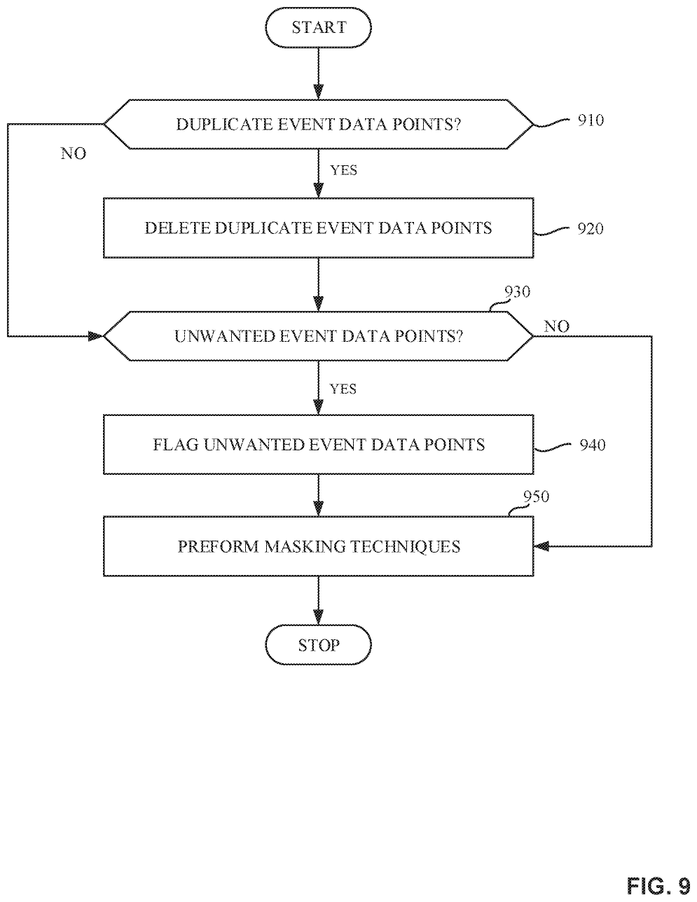

Flowcharts representative of example hardware logic, machine readable instructions, hardware implemented state machines, and/or any combination thereof for implementing the example target repository 302, the example event filter 304, the example report generation module 312, the example destination bucket 306, the example algorithm applicator 308, the example metric generator 310, and/or, more generally, the example back-end data processor 112 of FIGS. 1 and 3 is shown in FIGS. 9-11. The machine readable instructions may be an executable program or portion of an executable program for execution by a computer processor such as the processor 1312 shown in the example processor platform 1300 discussed below in connection with FIGS. 9-11. The program may be embodied in software stored on a non-transitory computer readable storage medium such as a CD-ROM, a floppy disk, a hard drive, a DVD, a Blu-ray disk, or a memory associated with the processor 1312, but the entire program and/or parts thereof could alternatively be executed by a device other than the processor 1312 and/or embodied in firmware or dedicated hardware. Further, although the example program is described with reference to the flowchart illustrated in FIGS. 9-11, many other methods of implementing the example meter may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

FIG. 9 is a flowchart representative of machine readable instructions that may be executed process the event data in the back-end data processor 112 of FIG. 1 and/or FIG. 3. The event filter 304, in communication with the target repository 302, determines if there are duplicate event data points (e.g., duplicate data points in the newly combined data) (block 910). If duplicate event data points are determined to exist, the event filter 304 removes and/or deletes the duplicated event data points (block 920). In other examples disclosed herein, the event filter 304 may ignore the duplicated event data points.

Additionally, the example event filter 304 determines if there are any unwanted event data points (block 930). Unwanted data points may consist of data points received that are irrelevant to the analysis performed. If unwanted event data points are available, the event filter 304 performs flagging techniques on the unwanted event data points (block 940). Example flagging techniques include categorically marking subsets of the received event data points on the basis of preset text-based rules.

The event filter 304 performs masking techniques on the received event data points (block 950). Masking techniques include masking personal identifiable information (PHI) using regular expression techniques (e.g., regex or regexp).

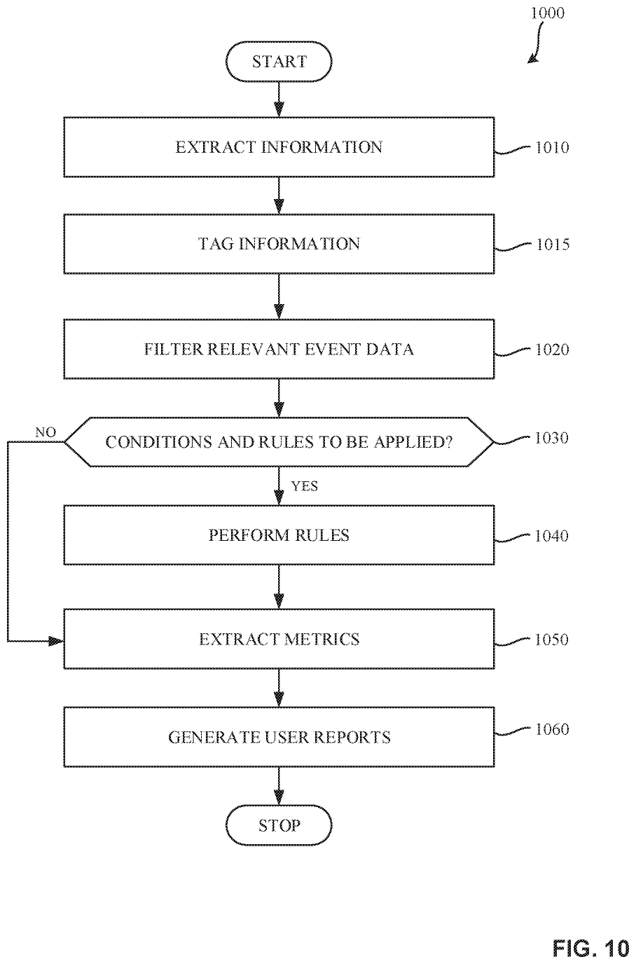

FIG. 10 is a flowchart 1000 representative of machine readable instructions that may be executed to apply necessary algorithms to the event data from the meter 106 of FIGS. 1 and/or 2. Information received at the back-end data processor 112, after initial pre-processing, is then further extracted by the event filter 304 (block 1010). In the example illustrated in FIG. 10, the target repository 302 and/or the event filter 304 tag the information as it is obtained (block 1015). In addition, the event filter 304 filters the relevant event data (block 1020). An example includes filtering out content such as presentation view time, and including content such as products viewed, for eCommerce applications.

The algorithm applicator 308 determines if conditions and/or rules are to be applied to the information (block 1030). In the event rules are to be applied, the algorithm applicator 308 executes the appropriate rules (block 1040). Additionally, the metric generator 310 and/or the algorithm applicator 308 extracts the relevant metrics (block 1050). After all the relevant event data and relevant metrics are extracted, tagged, and filtered, the report generation module 312 may then generate a report for the destination bucket 306 based on number of occurrences, duration, occurrence type, etc. (block 1060).

If the algorithm applicator 308 determines that conditions and/or rules are not to be applied, the metric generator 310 and/or the algorithm applicator 308 extract(s) the relevant metrics (block 1050). After all the relevant data and relevant metrics are extracted, tagged, and filtered, the report generation module 312 may then generate a report for the destination bucket 306 based on number of occurrences, duration, occurrence type, etc. (block 1060).

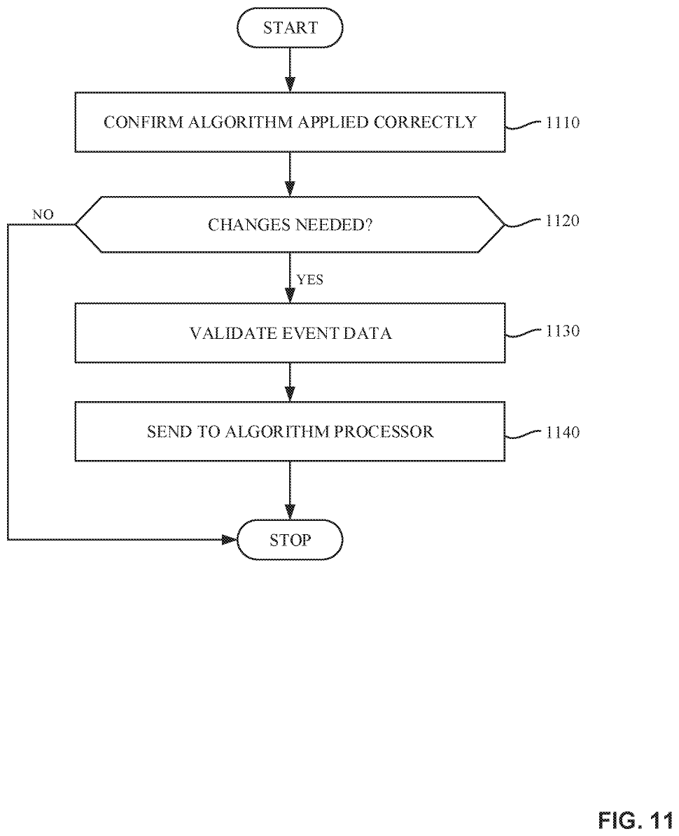

FIG. 11 is a flowchart representative of machine readable instructions that may be executed to detect possible problems encountered in the back-end data processor 112 of FIG. 1 and/or FIG. 3. The algorithm applicator 308 confirms if the algorithms previously applied by the algorithm applicator 308 are correct (block 1110). The example back-end data processor 112 determines if the algorithms were applied correctly or if changes and/or adjustments are needed (block 1120). If changes and/or adjustments are needed, the back-end data processor 112 validates the data (block 1130). In validating the event data, the back-end processor 112 will ascertain changes for in-app processing. Changes for in-app processing may be dependent on application updates, device screen size, layout changes in the application being monitored, etc. The back-end processor 112 sends the validated data back to the algorithm processor (block 1140).

As mentioned above, the example processes of FIGS. 9-11 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

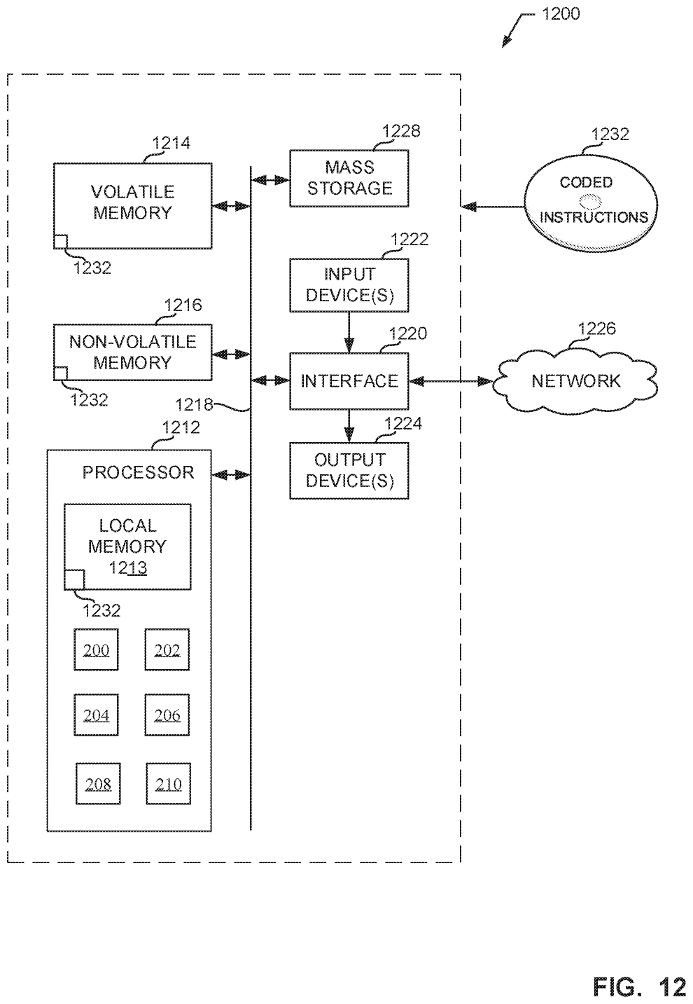

FIG. 12 is a block diagram of an example processing platform structured to execute the instructions of FIGS. 7-8, or to implement the meter 106 of FIG. 1 and/or FIG. 2. The processor platform 1200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 1200 of the illustrated example includes a processor 1212. The processor 1212 of the illustrated example is hardware. For example, the processor 1212 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example accessibility register 200, the example accessibility event receiver 202, the example event repository 204, the example event filter 206, the example measurement data generator 208, the example data transmitter 210 and/or, more generally, the example meter 106 of FIG. 1.

The processor 1212 of the illustrated example includes a local memory 1213 (e.g., a cache). The processor 1212 of the illustrated example is in communication with a main memory including a volatile memory 1214 and a non-volatile memory 1216 via a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1216 may be implemented by flash memory and/or any other desired type of memory device. Access to the main memory 1214, 1216 is controlled by a memory controller.

The processor platform 1200 of the illustrated example also includes an interface circuit 1220. The interface circuit 1220 may be implemented by any type of interface standard, such as an Ethernet interface, a universal serial bus (USB), a Bluetooth® interface, a near field communication (NFC) interface, and/or a PCI express interface.

In the illustrated example, one or more input devices 1222 are connected to the interface circuit 1220. The input device(s) 1222 permit(s) a user to enter data and/or commands into the processor 1212. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1224 are also connected to the interface circuit 1220 of the illustrated example. The output devices 1224 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 1220 of the illustrated example, thus, typically includes a graphics driver card, a graphics driver chip and/or a graphics driver processor.

The interface circuit 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1226. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1200 of the illustrated example also includes one or more mass storage devices 1228 for storing software and/or data. Examples of such mass storage devices 1228 include floppy disk drives, hard drive disks, compact disk drives, Blu-ray disk drives, redundant array of independent disks (RAID) systems, and digital versatile disk (DVD) drives.

The machine executable instructions 1232 of FIGS. 7-8 may be stored in the mass storage device 1228, in the volatile memory 1214, in the non-volatile memory 1216, and/or on a removable non-transitory computer readable storage medium such as a CD or DVD.

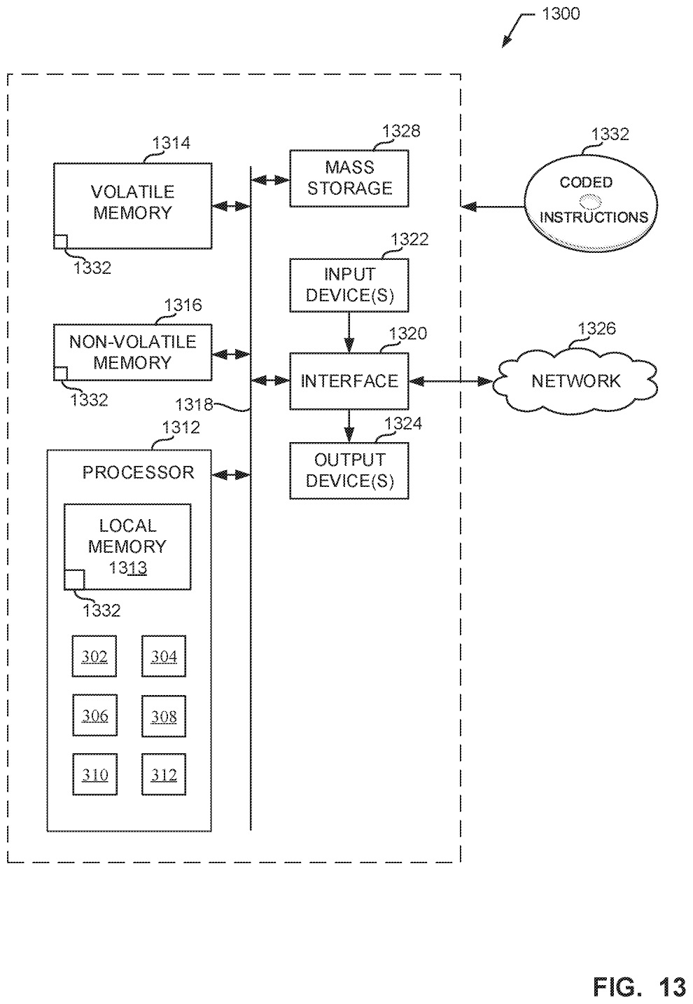

FIG. 13 is a block diagram of an example processing platform structured to execute the instructions of FIGS. 9-11, or to implement the back-end data processor 112 of FIG. 1 and/or FIG. 3. The processor platform 1300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 1300 of the illustrated example includes a processor 1312. The processor 1312 of the illustrated example is hardware. For example, the processor 1312 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example target repository 302, the example event filter 304, the example report generation module 312, the example destination bucket 306, the example algorithm applicator 308, the example metric generator 310, and/or, more generally, the example back-end data processor 112.

The processor 1312 of the illustrated example includes a local memory 1313 (e.g., a cache). The processor 1312 of the illustrated example is in communication with a main memory including a volatile memory 1314 and a non-volatile memory 1316 via a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1316 may be implemented by flash memory and/or any other desired type of memory device. Access to the main memory 1314, 1316 is controlled by a memory controller.

The processor platform 1300 of the illustrated example also includes an interface circuit 1320. The interface circuit 1320 may be implemented by any type of interface standard, such as an Ethernet interface, a universal serial bus (USB), a Bluetooth® interface, a near field communication (NFC) interface, and/or a PCI express interface.

In the illustrated example, one or more input devices 1322 are connected to the interface circuit 1320. The input device(s) 1322 permit(s) a user to enter data and/or commands into the processor 1312. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1324 are also connected to the interface circuit 1320 of the illustrated example. The output devices 1324 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 1320 of the illustrated example, thus, typically includes a graphics driver card, a graphics driver chip and/or a graphics driver processor.

The interface circuit 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1326. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1300 of the illustrated example also includes one or more mass storage devices 1328 for storing software and/or data. Examples of such mass storage devices 1328 include floppy disk drives, hard drive disks, compact disk drives, Blu-ray disk drives, redundant array of independent disks (RAID) systems, and digital versatile disk (DVD) drives.

The machine executable instructions 1332 of FIGS. 9-11 may be stored in the mass storage device 1328, in the volatile memory 1314, in the non-volatile memory 1316, and/or on a removable non-transitory computer readable storage medium such as a CD or DVD.

From the foregoing, it will be appreciated that example methods, apparatus and articles of manufacture have been disclosed that provide collection facilities with pre-specified, filtered, and organized event data from user devices. The disclosed methods, apparatus and articles of manufacture improve the efficiency of using a computing device by collecting and organizing inaccessible event data on a computing device without disrupting the user device and utilizing processing power to communicate with content providers directly. The disclosed methods, apparatus and articles of manufacture are accordingly directed to one or more improvement(s) in the functioning of a computer.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. An apparatus comprising:
an accessibility event receiver to obtain event data from an accessibility application programming interface of a computing device;
an event repository coupled to the accessibility event receiver, the event repository to store the event data;
an event filter coupled to the event repository, the event filter to filter the event data based on a set of rules to identify media presentation information;
a measurement data generator coupled to the event filter, the measurement data generator to generate media measurement information based on the media presentation information; and
a data transmitter coupled to the measurement data generator to transmit the media measurement information to a collection facility.

2. The apparatus of claim 1, wherein the event filter is to sort and filter the media measurement information based on data type.

3. The apparatus of claim 1, wherein a meter is installed on a user device in response to receiving a permission to download.

4. The apparatus of claim 1, wherein the measurement data generator combines onscreen data points with custom field data.

5. The apparatus of claim 1, wherein the event filter includes the set of rules to filter data unrelated to a presentation of media.

6. The apparatus of claim 5, wherein the accessibility event receiver monitors user navigation and feedback through an Accessibility service.

7. The apparatus of claim 6, wherein the Accessibility service is Android Accessibility service.

8. A method for collecting audience measurement data, the method comprising:
filtering event data based on a set of rules to identify media presentation information, the event data obtained from an accessibility application programming interface of a computing device;
generating media measurement information based on the media presentation information; and
transmitting the media measurement information to a collection facility.

9. The method of claim 8, further including, combining the media presentation information with custom fields.

10. The method of claim 8, further including monitoring user navigation and feedback through an Accessibility service.

11. The method of claim 10, wherein the Accessibility service is Android Accessibility service.

12. The method of claim 8, wherein the set of rules include rules to filter data unrelated to a presentation of media.

13. The method of claim 8, further including obtaining the event data in response to determining an accessibility event has occurred.

14. A non-transitory computer readable medium on which instructions are stored, comprising instructions that when executed cause a machine to at least:
filter, event data based on a set of rules to identify media presentation information, the event data obtained from an accessibility application programming interface of a computing device;
generate media measurement information based on the media presentation information; and
transmit the media measurement information to a collection facility.

15. The computer readable medium of claim 14, further including, combining the media presentation information with custom fields.

16. The computer readable medium of claim 14, wherein a meter is installed on a user device in response to receiving a permission to download.

17. The computer readable medium of claim 14, wherein a measurement data generator combines event data with custom fields.

18. The computer readable medium of claim 14, wherein an event filter includes the set of rules to filter data unrelated to a presentation of media.

19. The computer readable medium of claim 14, further including monitoring user navigation and feedback through an Accessibility service.

20. The computer readable medium of claim 19, wherein the Accessibility service is Android Accessibility service.

21. (canceled)
